(19) United States
(12) Patent Application Publication
(10) Pub. No.: US 2024/0399543 A1
(43) Pub. Date: Dec. 5, 2024

(54) Multi-angle ratchet wrench

(71) Applicants: Neng-Chia Shih, Lukang Township (TW); Tsuan-Tsang Lee, Taichung City (TW); ZHEJIANG MAXTOP TOOLS MANUFACTURE CO., LTD, Wenling (CH)

(72) Inventor: Neng-Chia Shih, Changhua County (TW)

(21) Appl. No.: 18/204,775

(22) Filed: Jun. 1, 2023

(51) Int. Cl. B25B 13/46; B25B 23/00

(52) U.S. Cl. CPC B25B 13/463; B25B 23/0028

(57) ABSTRACT

A multi-angle ratchet wrench has a handle member, a working head, and a ratchet unit. One end of the handle member is provided with a first pivoting end and a second pivoting end and a shared space between the first and second pivoting ends, and both the first and second pivoting ends are provided with a shaft hole and a detent hole. The working end is swingably bolted in the shared space with a third pivoting end coupled with a shaft bolt, and the end edge of the third pivoting end has an arc-shaped ratchet portion. The ratchet unit is accommodated in the detent hole, which has an elastic member and a switching button, and the outer diameter of the switching button has an idling section and a toothed section facing the shared space and a limiting wall is formed closer to the toothed section.

### BACKGROUND OF INVENTION

### Field of Invention

The present invention relates to a ratchet wrench, and more particularly to a multi-angle ratchet wrench.

### Description of Related Art

A conventional multi-angle ratchet wrench includes: a first lever, a second lever and a pivoting shaft. The first lever is provided with the first pivoting end, and the first pivoting end is provided with a first pivot hole axially along a virtual pivot axis. The second lever is provided with a second pivoting end and a third pivoting end, the first pivoting end is provided between the second pivoting end and the third pivoting end. The second pivoting end is provided with a second pivot hole, the inner periphery of the second pivoting hole is provided with a first ratchet portion and a limiting groove and a limiting member is arranged in the limiting groove. The third pivoting end is provided with a third pivoting hole. The pivoting shaft is inserted into the first pivot hole, the second pivot hole and the third pivot hole so as to move between the locking position and the pivoting position along the axis of the pivot shaft. The outer peripheral edge of the pivot shaft is provided with a second ratchet portion, a first positioning groove and a second positioning groove. When the pivot shaft is in the locked position, the second ratchet portion is connected to the ratchet portion, and the limiting member is fastened to the first positioning groove. The first lever and the second lever cannot pivot relative to each other. When the pivot shaft is at the pivot position, the limiting member is fastened to the second positioning groove, and the first lever and the second lever can pivot relative to each other.

It is not difficult to find that there are still some problems in the above-mentioned structure, and the main reasons are as follows: the first lever and the second lever of the conventional multi-angle wrench have relative pivots with the pivot as the axis, the second ratchet portion of the pivot is also aligned with the first ratchet portion of the second lever. When locking through the pivot shaft, the second ratchet portion of the outer periphery needs to be aligned with the inner periphery of the second pivot hole. The first ratchet portion is completely in contact with each other, which leads to extremely high precision requirements between the first and second ratchet portions, otherwise it is easy to cause interference and cause locking problems, and at the same time increase the cost of structural components.

Moreover, when the first and second levers reach the pivoting and locking states through the pivot shaft, the pivot system utilizes the first and second positioning grooves and the second lever's limiting member in the limiting groove to engage, so that it is necessary to repeatedly press the pivot shaft to move for swinging and locking, which not only is confusing and unclear, also requires to reconfirm whether the pivot has been locked. On the other hand, the limiting member is similar to an elastic C-shaped fasteners, under the extremely complicated pressing and switching control, the first and second positioning grooves or the limiting members are prone to wear due to friction, which leads to the pivot shaft cannot be snapped and positioned with the limiting members, seriously affecting practicality and durability of the wrench.

Therefore, it is desirable to provide a multi-angle ratchet wrench to mitigate and/or obviate the aforementioned problems.

### SUMMARY OF THE INVENTION

An objective of the present invention is to provide a multi-angle ratchet wrench which is easy to manufacture and providing better steadiness.

In order to achieve the above mentioned objective, a multi-angle ratchet wrench has a handle member, a working head, and a ratchet unit. One end of the handle member is provided with a first pivoting end and a second pivoting end and a shared space between the first and second pivoting ends, and both the first and second pivoting ends are provided with a shaft hole and a detent hole. The working end is swingably bolted in the shared space with a third pivoting end coupled with a shaft bolt, and the end edge of the third pivoting end has an arc-shaped ratchet portion. The ratchet unit is accommodated in the detent hole, which has an elastic member and a switching button, and the outer diameter of the switching button has an idling section and a toothed section facing the shared space and a limiting wall is formed closer to the toothed section.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment of the present invention.

FIG. 2 is an exploded view according to the preferred embodiment of the present invention.

FIG. 3 is a cross-sectional view of the engaging positioning state according to the preferred embodiment of the present invention.

FIG. 4 is another cross-sectional view of the engaging positioning state according to the preferred embodiment of the present invention.

FIG. 5 is a cross-sectional view of the idling swing state according to the preferred embodiment of the present invention.

FIG. 6 is another perspective cross-sectional view and partially enlarged schematic diagram of the idling swing state according to the preferred embodiment of the present invention.

FIG. 7 is a schematic diagram of the working end swinging left and right according to the preferred embodiment of the present invention FIG. 8 is a cross-sectional view showing the switching button being reset by the elastic member to form an engaging positioning state according to the preferred embodiment of the present invention.

FIG. 9 is a cross-sectional view of the working end being adjusted and engaged according to the preferred embodiment of the present invention.

FIG. 10 is a schematic diagram of the working end being adjusted and engaged according to the preferred embodiment of the present invention.

### DESCRIPTION OF THE PREFERRED EMBODIMENT

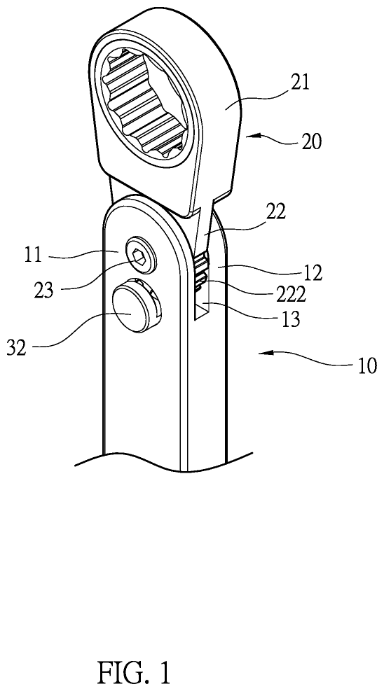

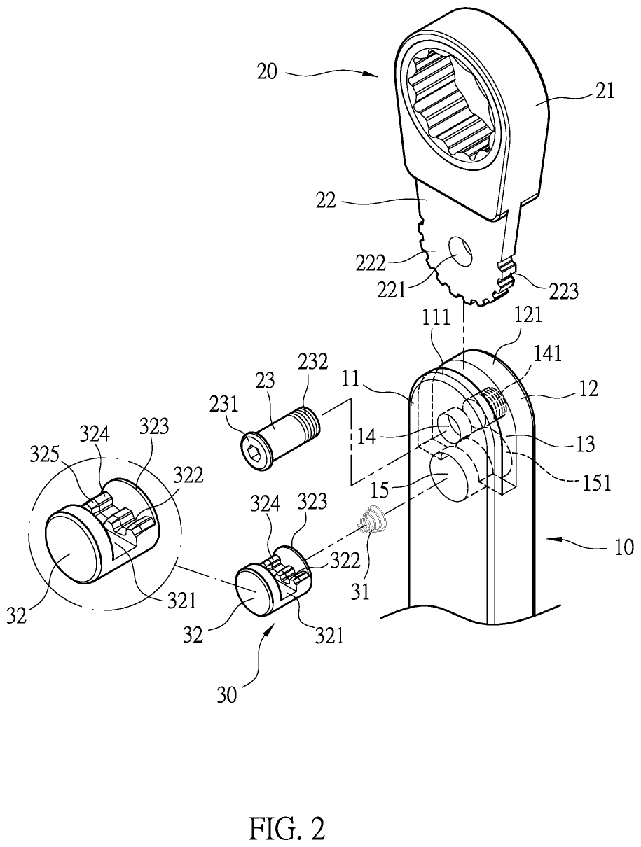

First, please refer to FIG. 1 and FIG. 2. A multi-angle ratchet wrench comprises: a handle member 10 a, working head 20 and a ratchet unit 30. The handle member 10 has a first pivoting end 11 and a second pivoting end 12 paired with each other at one end and a shared space 13 between the first and second pivoting end 11, 12. The shared space 13 has a flat bottom, and the first and second pivoting end 11, 12 both respectively have a shaft hole 14 connected to the shared space 13. The shaft hole 14 of the second pivoting end 12 has an inner thread section 141, the upper ends of the first and second pivoting end 11, 12 are centered on the shaft hole 14 to form an arc end 111, 121, and the first and second pivoting end 11, 12 both respectively have a detent hole 15 below the shaft hole 14 and connected to the shared space 13. The detent hole 15 stops before passing through the second pivoting end 12 to form a blocking wall 151, and the second pivoting end 12 is thicker than the first pivoting end 11, such that the detent hole 15 has sufficient depth in the second pivoting end 12, and at least half of the depth of the detent hole 15 is lower than the shared space 13. The working head 20 has a working end 21 and a third pivoting end 22. The third pivoting end 22 has an axial through hole 221 coupled with a shaft bolt 23 to pivot the third pivoting end 22 in the shared space 13, and a ratchet portion 222 with a plurality of ratchet teeth disposed 223 at an edge of the third pivoting end 22 and centered on the axial through hole 221. One end of the shaft bolt 23 has a stopping portion 231, and another end of the shaft bolt 23 has an outer threaded section 232 for locking the shaft bolt 23 in the shaft hole 14. Furthermore, the ratchet unit 30 is mounted in the detent hole 15 of the first and second pivoting end 11, 12 and have an elastic member 31 and a switching button 32. The switching button 32 has an idling section 321 and a toothed section 322 facing the shared space 13 and a limiting wall 323 adjacent to the toothed section 322, and the toothed section 322 has a plurality of teeth 324 higher than the idling section 321. The edge of teeth 324 is provided with a guiding slope 325 toward the idle section 321, the elastic member 31 is interposed between the retaining wall 151 and one end of the cut control button 32, and the cut control button 32 is capable of controlling the angle adjustment and positioning of the working head 20.

Moreover, the working end 20 is a ratchet end.

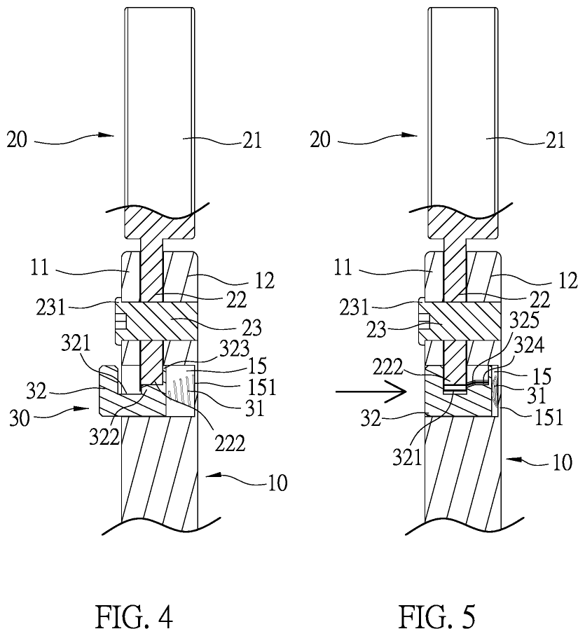

As for the composition of the structure of the embodiment, please refer to FIGS. 1, 2, 3, and 4. The elastic member 31 of the ratchet unit 30 and the switching button 32 are sequentially assembled into the detent hole 15, the elastic member 31 is disposed in the detent hole 15 of the second pivoting end 12 first, then the limiting wall 323 of the switching button 32 is inserted into the detent hole 15. Furthermore, the elastic member 31 is limited between the limiting wall 323 and the blocking wall 151, the idling section 321 and the toothed section 322 of the switching button 32 are arranged upwardly in the shared space 13, the third pivoting end 22 of the working head 20 is installed at the shared space 13 between the first and second pivoting end 11 and 12, and the axial through hole 221 is aligned to the shaft hole 14. At the same time, the ratchet portion 222 of the third pivoting end 22 is adjacent to the bottom of the shared space 13 and engages with the toothed section 322 of the switching button 32, the ratchet tooth 223 and tooth 324 also engage with each other, and the switching button 32 is pushed outward by the elastic member 31 and the limiting wall 323 abut against to one side of the third pivoting end 22 so the third pivoting end 22 limits the switching button 32 to prevent the switching button 32 from popping out from the detent hole 15. Accordingly, the switching button 32 fits to limit the third pivoting end 22, and finally the shaft bolt 23 is placed and locked through the shaft hole 14 and the axial through hole 221, so that the working head 20 is capable of rotating to a swing angle of at least 180° in the shared space 13 with the shaft bolt 23 as the axis, to form a multi-angle wrench structure.

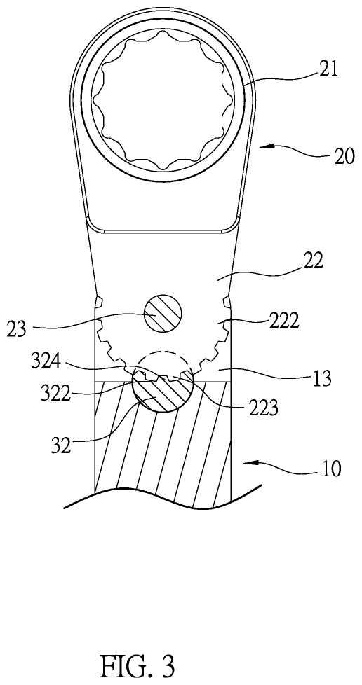

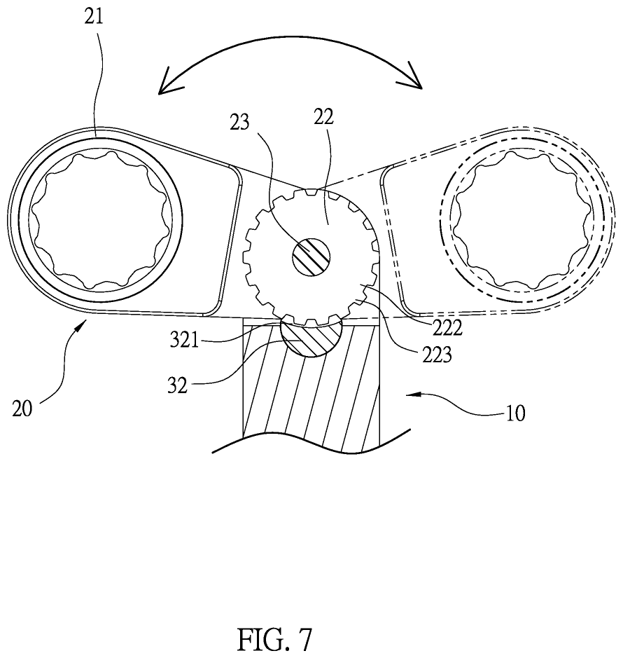

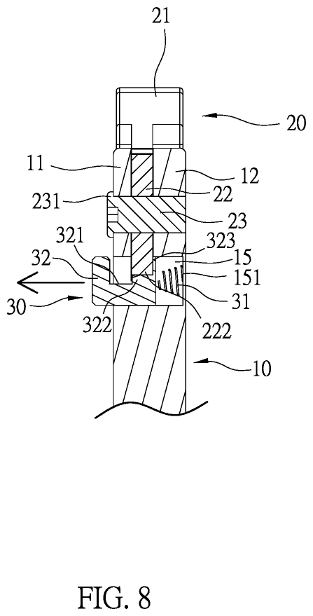

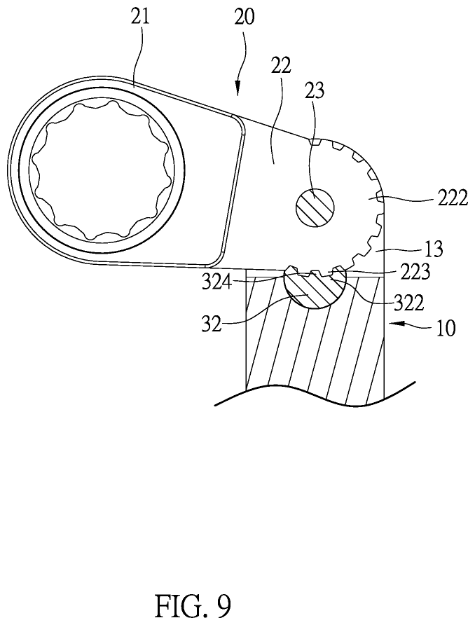

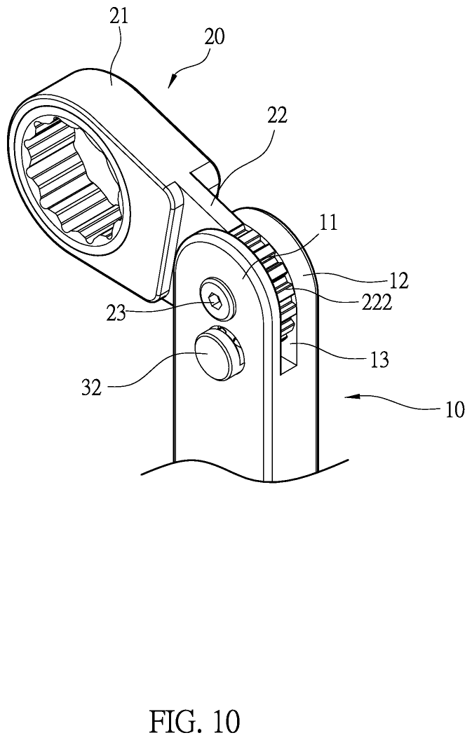

For the actual use of the structure, please refer to FIG. 3 to FIG. 7. When the switching button 32 of the ratchet unit 30 is not pressed, the teeth 324 of the toothed section 322 are engaged with the ratchet teeth 223 of the ratchet portion 222 to position the third pivoting end 22 and further restrict the angle of the working head 20 relative to the handle member 10. In order to adjust the working angle of the working head 20, the switching button 32 is pressed to retract and compresses the elastic member 31, to retracts the toothed section 322 of the switching button 32 into the detent hole 15 of the second pivoting end 12; and at the same time the idling section 321 is moved to face the shared space 13, the ratchet tooth 223 of the ratchet portion 222 is capable of being disengaged from the teeth 324, and the third pivoting end 22 can be freely rotated through the idling section 321, so that the working angle of the working head 20 can be adjusted. After the working angle is adjusted, please refer to FIGS. 8, 9 and 10, the switching button 32 is released and reset by rebound push from the elastic member 31, so that the toothed Section 322 returns to being connected with the shared space 13, and the ratchet tooth 223 of the third pivoting end 22 engage with the teeth 324 again, to achieve the purpose of adjusting the angle and positioning of the working head 20.

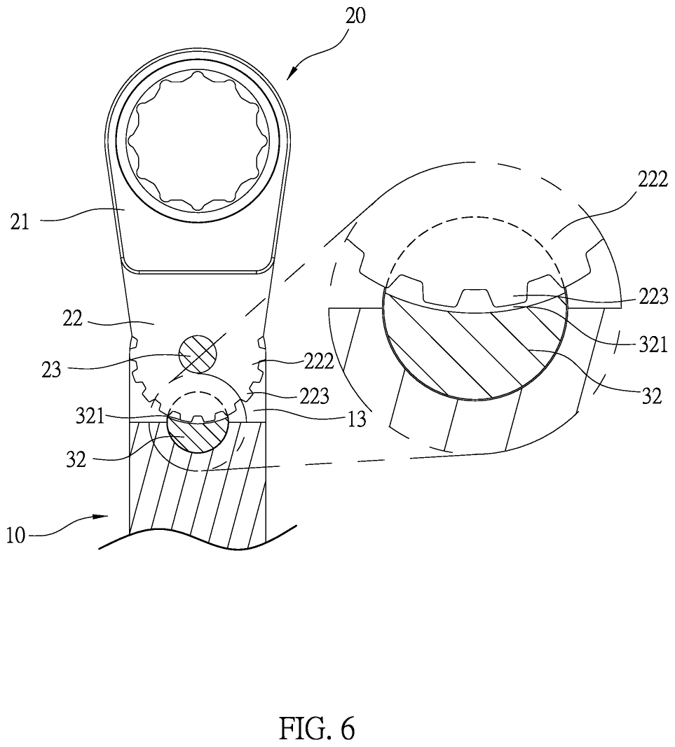

In addition, when the switching button 32 is pushed and reset by the elastic member 31, the guiding slope 325 on the edge of the tooth 324 of the toothed section 322, as shown in FIGS. 5 and 8, is capable of effectively avoiding the interference between the tooth 324 and the ratchet tooth 223, so that the tooth 324 can be smoothly and quickly introduced between the ratchet tooth 223, and the effect of engaging and positioning can be indeed achieved.

With the structure of the above-mentioned specific embodiment, the following benefits can be obtained: when the working head 20 is locked with the handle member 10, the concave arc-shaped toothed section 322 of the switching button 32 engage with the arc-shaped ratchet portion 222 of the third pivoting end 22, which effectively reduces the contact area between parts to not only avoid the occurrence of interference that leads to inaccurate positioning of the ratchet, but also reduce the accuracy requirements for lower structural costs, while simplifying the structural composition and ensuring the substantial effect of engagement positioning.

When in order to adjust the working head 20, the switching button 32 is pressed to disengage the toothed section 322 from the ratchet portion 222 of the third pivoting end 22 to allow the working head 20 to move. When the switching button 32 is released and pushed back through the elastic member 31, the switching button 32 is quickly reset and positioned and engages with the ratchet portion 222 via the toothed section 322, so that the angle adjustment and positioning of the working head 20 can be operated more easily and effortless with practicality and durability.

Although the present invention has been explained in relation to its preferred embodiment, it is to be understood that many other possible modifications and variations can be made without departing from the spirit and scope of invention as hereinafter claimed.

What is claimed is:

1. A multi-angle ratchet wrench comprising:
a handle member with a first pivoting end and a second pivoting end paired with each other at one end and a shared space between the first and second pivoting ends, the first and second pivoting ends both respectively having a shaft hole connected to the shared space and a detent hole below the shaft hole and connected to the shared space, the detent hole stopping before passing through the second pivoting end to form a blocking wall;
a working head with a working end and a third pivoting end having an axial through hole coupled with a shaft bolt to pivot the third pivoting end in the shared space, and a ratchet portion with a plurality of ratchet teeth disposed at an edge of the third pivoting end and centered on the axial through hole; and
a ratchet unit mounted in the detent hole of the first and second pivoting end and having an elastic member and a switching button, the switching button having an idling section and a toothed section facing the shared space and a limiting wall adjacent to the toothed section, the toothed section having a plurality of teeth higher than the idling section; the elastic member disposed between the blocking wall and the switching button for controlling angle adjustment of the working head.

2. The multi-angle ratchet wrench as claimed in claim 1, wherein the shaft hole of the second pivoting end further comprises an inner threaded section, one end of the shaft bolt has a stopping portion and another end of the shaft bolt has an outer threaded section for locking the shaft bolt in the shaft hole.

3. The multi-angle ratchet wrench as claimed in claim 1, wherein the second pivoting end is thicker than the first pivoting end, such that the detent hole has sufficient depth in the second pivoting end for accepting the elastic member, and at least half of the depth of the detent hole is lower than the shared space.

4. The multi-angle ratchet wrench as claimed in claim 1, wherein an upper end of both of the first and second pivoting ends are centered from the shaft hole, and the shared space has a flat bottom allowing the working end to have at least a 180° swing angle.

5. The multi-angle ratchet wrench as claimed in claim 1, wherein both the toothed section and the idling section of the switching button have concave arc profiles, and a top of each tooth of the toothed section has a guiding slope towards the idling section.

6. The multi-angle ratchet wrench as claimed in claim 1, wherein the working end is a ratchet end.
